(19) United States
(12) Patent Application Publication
(10) Pub. No.: US 2020/0191279 A1
(43) Pub. Date: Jun. 18, 2020

(54) INFLATION VALVE ASSEMBLY

(71) Applicant: Goodrich Corporation, Charlotte, NC (US)

(72) Inventors: Poly Puthur John, Trivandrum (IN); Srivinay Basavaraju Pondhe, Bangalore (IN)

(21) Appl. No.: 16/268,666

(22) Filed: Feb. 6, 2019

(30) Foreign Application Priority Data
Dec. 12, 2018 (IN) 201811047032

(51) Int. Cl. F16K 1/30; F16K 31/06

(52) U.S. Cl. CPC F16K 1/30; B64D 25/14; F16K 31/06

(57) ABSTRACT

An inflation valve assembly includes a first valve assembly and a second valve assembly. The first valve assembly including a first valve housing defining a first valve inlet, a first valve outlet, and first valve bore, and a first valve poppet movably disposed within the first valve bore. The second valve assembly including a second valve housing connected to the first valve housing, the second valve housing defining a second valve bore, and a second valve poppet extending from a plunger movably disposed within the second valve bore. The second valve poppet extending into the first valve bore and being arranged to selectively engage the first valve poppet.

### FOREIGN PRIORITY

This application claims priority to Indian Patent Application No. 201811047032 filed Dec. 12, 2018, the entire contents of which is incorporated herein by reference.

### BACKGROUND

Exemplary embodiments pertain to the art of inflation valve assemblies.

Pneumatic inflation systems discharge a high pressure stored gas to entrain air to inflate an inflatable device. The high pressure stored gas is to be discharged within a specified time by the opening an inflation valve. Pressure relief valves are provided with the inflatable device to release excess gas after the inflatable device achieves the desired inflation pressure. Commonly electrical squib operate inflation valves are provided with the pneumatic inflation system. The electrical squib may involve explosive material that may potentially present regulatory issues as well as cause the inflation valve to be a one use valve.

### BRIEF DESCRIPTION

Disclosed is an inflation valve assembly that includes a first valve assembly and a second valve assembly. The first valve assembly including a first valve housing defining a first valve inlet, a first valve outlet, and first valve bore, and a first valve poppet movably disposed within the first valve bore. The second valve assembly including a second valve housing connected to the first valve housing, the second valve housing defining a second valve bore, and a second valve poppet extending from a plunger movably disposed within the second valve bore. The second valve poppet extending into the first valve bore and being arranged to selectively engage the first valve poppet.

Also disclosed is an inflation valve assembly that includes a first valve assembly and a second valve assembly. The first valve assembly includes a first valve housing defining a first valve inlet, a first valve outlet, a first valve seat, and a first valve bore, and a first valve poppet movably disposed within the first valve bore and arranged to selectively engage the first valve seat to selectively inhibit fluid flow between the first valve inlet and the first valve outlet. The first valve poppet defining a bleed port that extends from a first valve poppet first face towards a first valve poppet second face and a second valve seat that extends from the first valve poppet second face. The second valve assembly including a second valve housing, an actuator assembly, and a second valve poppet. The second valve housing is connected to the first valve housing and defines a second valve bore. The actuator assembly extends into the second valve bore. The actuator assembly has a plunger movably disposed within the second valve bore. The second valve poppet extends from the plunger and into the first valve bore.

### BRIEF DESCRIPTION OF THE DRAWINGS

The following descriptions should not be considered limiting in any way. With reference to the accompanying drawings, like elements are numbered alike:

FIG. 1 is a schematic illustration of an inflation valve assembly in a closed position;

FIG. 2 is a schematic illustration of the inflation valve assembly in an intermediate position, moving towards the open position;

FIG. 3 is a schematic illustration of the inflation valve assembly in an open position; and

FIG. 4 is a schematic illustration of the inflation valve assembly in the intermediate position, moving towards the closed position.

### DETAILED DESCRIPTION

A detailed description of one or more embodiments of the disclosed apparatus and method are presented herein by way of exemplification and not limitation with reference to the Figures.

An inflatable structure or an inflatable device may be provided with a vehicle, such as an aircraft. The inflatable device may be an evacuation slide, raft, or other inflatable structure. The inflatable device may be used for emergency evacuation of the aircraft and is arranged to be packaged within a compartment of the aircraft (i.e. the aircraft door, aircraft frame, a packboard housing inside the fuselage, a slide bustle, etc.). An inflation system is provided to rapidly inflate the inflatable device from an un-deployed condition to a deployed condition, in which the inflatable device is ready for use, such as flotation or evacuation. Responsive to a request to evacuate the aircraft using the inflatable device, the inflation system utilizes a source of pressurized gas or fluid such as a container or bottle of compressed gas that is suitably mounted relative to the inflatable device and is connected to an aspirator, to rapidly inflate the inflatable device.

An inflation valve assembly 10 is provided to regulate a fluid flow to the inflatable device. The inflation valve assembly 10, unlike traditional valve assemblies that employ an electrical squib or pneumatic actuators, the inflation valve assembly 10 may be a solenoid or other form of actuator actuated valve having internal piloting actuation with repeatable operational features.

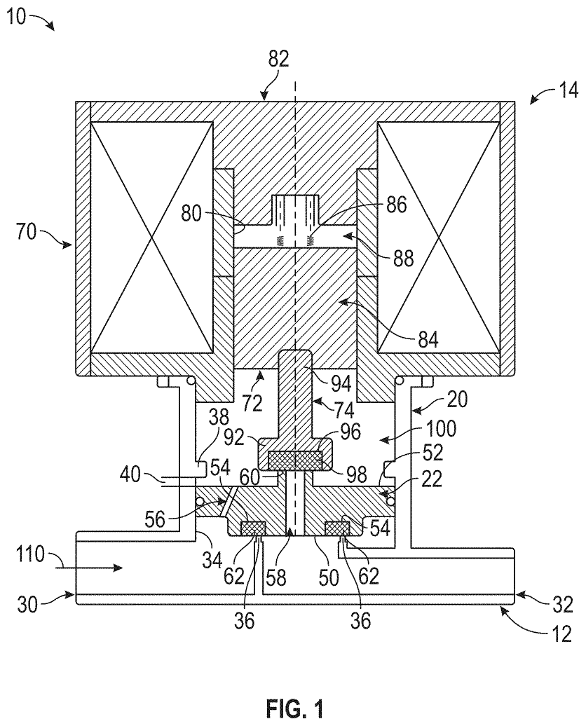

Referring to FIGS. 1-4, the inflation valve assembly 10 includes a first valve assembly 12 that is connected to a second valve assembly 14. The first valve assembly 12 is arranged to selectively facilitate a fluid flow from a fluid source to the inflatable device and the second valve assembly 14 is arranged to regulate the operation of the first valve assembly 12.

The first valve assembly 12 includes a first valve housing 20 and a first valve poppet 22 movably disposed within the first valve housing 20. The first valve housing 20 defines a first valve inlet 30, a first valve outlet 32, a first valve bore 34, and a first valve seat 36.

The first valve inlet 30 is disposed parallel to the first valve outlet 32, in the arrangement shown. However, other arrangements of the first valve inlet 30 relative to the first valve outlet 32 are possible. The first valve bore 34 is disposed substantially perpendicular to the first valve inlet 30 and the first valve outlet 32, in the arrangement shown. The first valve poppet 22 is movably disposed within the first valve bore 34. The first valve poppet 22 is arranged to engage the first valve seat 36 to inhibit a fluid flow between the first valve inlet 30 and the first valve outlet 32.

The first valve housing 20 defines a stop 38 that extends into the first valve bore 34. The stop 38 is arranged to restrict the total stroke 40 of the first valve poppet 22 within the first valve bore 34.

The first valve poppet 22 includes a first valve poppet first face 50 and a first valve poppet second face 52. The first valve poppet first face 50 is arranged to selectively engage the first valve seat 36. The first valve poppet 22 defines a first sealing groove 54, a bleed port 56, a valve port 58, and a second valve seat 60.

The first sealing groove 54 extends from the first valve poppet first face 50 towards the first valve poppet second face 52. The sealing member 62 is received within the first sealing groove 54 to enhance sealing between the first valve poppet 22 and the first valve seat 36.

The bleed port 56 extends from the first valve poppet first face 50 towards the first valve poppet second face 52. The valve port 58 is spaced apart from the bleed port 56. The valve port 58 extends from the first valve poppet first face 50 towards the first valve poppet second face 52. The bleed port 56 is a first cross-sectional form and the valve port 58 has a second cross-sectional form that is greater than the first cross-sectional form of the bleed port 56.

The second valve seat 60 may be defined by the first valve poppet second face 52. The second valve seat 60 may extend from the first valve poppet second face 52. The valve port 58 extends through the second valve seat 60.

The second valve assembly 14 includes a second valve housing 70, an actuator assembly 72, and a second valve poppet 74.

The second valve housing 70 is connected to the first valve housing 20. The second valve housing 70 defines a second valve bore 80 that receives portions of the actuator assembly 72. The actuator assembly 72 includes a solenoid assembly 82, a plunger 84, and a biasing member 86. The solenoid assembly 82 is disposed proximate a distal end of the second valve housing 70. The solenoid assembly 82 extends into the second valve bore 80. The plunger 84 is slidably disposed within the second valve bore 80 and is movable relative to the solenoid assembly 82. An air gap 88 is defined between ends of the solenoid assembly 82 and the plunger 84. Activation of the solenoid assembly 82 moves the plunger 84 within the second valve bore 80 towards the solenoid assembly 82 to narrow or close the air gap 88. The biasing member 86 is disposed within the air gap 88 and is arranged to bias the plunger 84 towards the first valve poppet 22 such that the second valve poppet 74 engages the second valve seat 60 inhibit a fluid flow through the valve port 58.

The second valve poppet 74 has a second valve poppet first end 92 and a second valve poppet second end 94. The second valve poppet first end 92 defines a sealing groove 96 that is arranged to receive a sealing member 98 that is arranged to selectively engage the second valve seat 60. The second valve poppet second end 94 extends into the plunger 84 such that the second valve poppet 74 extends from the plunger 84 and is disposed opposite the air gap 88. The second valve poppet 74 extends into the first valve bore 34 and is arranged to selectively engage the second valve seat 60 of the first valve poppet 22.

A fluid cavity 100 is defined by or between the first valve poppet second face 52, the first valve bore 34, the second valve housing 70, and the plunger 84. Referring to FIG. 1, a fluid flow 110 received through the first valve inlet 30 from a pressurized gas source, while the first valve poppet 22 engages the first valve seat 36 and while the second valve poppet 74 engages the second valve seat 60, flows or is bled through the bleed port 56 to pressurize the fluid cavity 100. The pressurization of the fluid cavity 100 increases the sealing force of the plunger 84 with the second valve seat 60 and increases the sealing force of the first valve poppet 22 with the first valve seat 36.

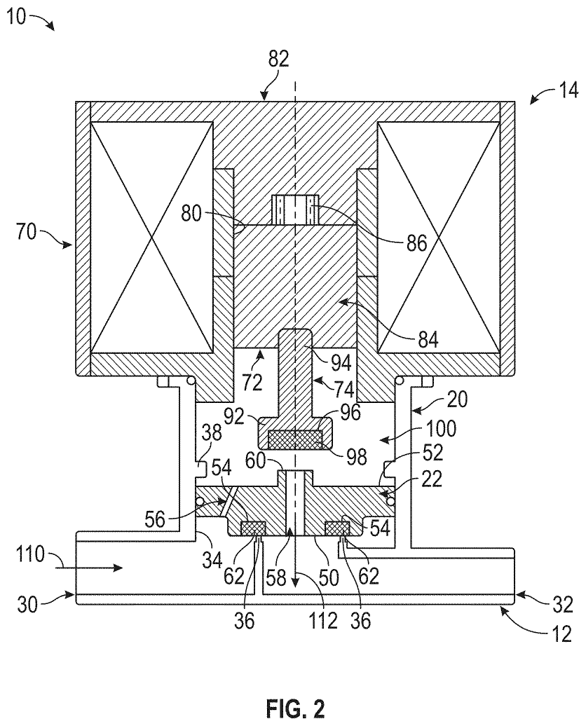

Referring to FIG. 2, responsive to actuation or energizing of the solenoid assembly 82, the plunger 84 moves within the second valve bore 80 towards the solenoid assembly 82 to close the air gap 88. The movement of the plunger 84 spaces the second valve poppet 74 apart from engagement with the second valve seat 60 to fluidly connect the fluid cavity 100 with the valve port 58 and the first valve outlet 32. Fluid communication between the fluid cavity 100 and the valve port 58 enables the fluid cavity 100 to be evacuated via evacuation flow 112 to release or reduce pressure within the fluid cavity 100.

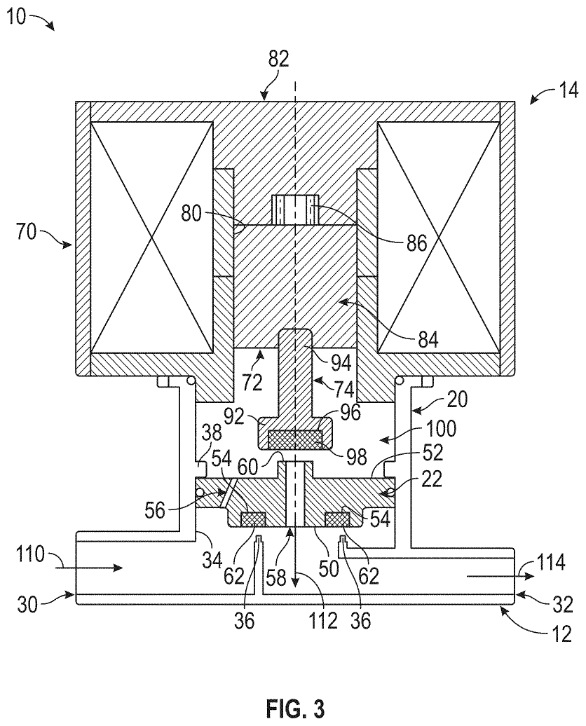

Referring to FIGS. 2 and 3, due to the larger valve port 58 cross-sectional form as compared to the bleed port 56 cross-sectional form, the fluid cavity 100 is evacuated faster than the pressure increase of the fluid cavity 100 through the bleed port 56. Therefore, the larger the ratio between the valve port 58 and the bleed port 56 results in a faster opening of the first valve assembly 12. As the pressure within the fluid cavity 100 reduces, responsive to flow through the valve port 58, the pressure difference across the first valve poppet 22 causes the first valve poppet 22 to move towards the second valve housing 70 such that the first valve poppet 22 is spaced apart from the first valve seat 36 to fluidly connect the first valve inlet 30 and the first valve outlet 32 to provide a fluid flow 114 to the inflatable device. The stop 38 is arranged to engage the first valve poppet second face 52 of the first valve poppet 22 to inhibit further movement of the first valve poppet 22 towards the second valve housing 70.

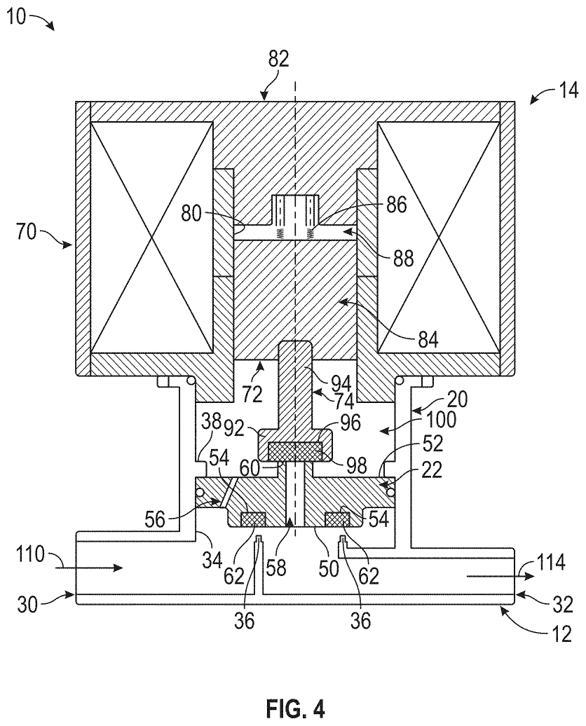

Referring to FIG. 4, responsive to de-energizing of the solenoid assembly 82, the plunger 84 moves within the second valve bore 80 towards the first valve poppet 22. The biasing member 86 encourages the plunger 84 and the second valve poppet 74 to engage the second valve seat 60. As the fluid pressure proximate the first valve outlet 32 reduces further, the first valve poppet 22 continues to move towards the first valve seat 36 and may ultimately close the first valve assembly 12, as shown in FIG. 2. However, the first valve poppet 22 may not engage the first valve seat 36 to close the first valve assembly 12.

Closing of the first valve assembly 12 at the completion of an inflation of the inflatable device may not be mandatory. At the end of the inflation, as the pressure reduces, the pressure force along with the biasing force applied by the biasing member 86 may not be sufficient to move the first valve poppet 22 towards engagement with the first valve seat 36 of the first valve housing 20. However, the biasing member 86 may be sized to encourage the closing of the first valve assembly 12. For the general application, a minimum threshold pressure differential shall be defined between the first valve inlet 30 and the first valve outlet 32 for the proper engagement of the first valve poppet 22 with first valve seat 36 during closing.

The inflation valve assembly 10 that employs a first valve assembly 12 that is actuated by the second valve assembly 14 provides an integrated valve unit. The integrated valve unit reduces the overall envelope size of the inflation valve assembly 10 as well as achieves faster response times for the opening and closing of the inflation valve assembly 10. Furthermore, the inflation valve assembly 10 eliminates a pneumatic actuator cavity and pilot pressure feed line as used with external piloted valves, reducing the pneumatic time delay.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An inflation valve assembly, comprising:
a first valve assembly, comprising:
a first valve housing defining a first valve inlet, a first valve outlet, and first valve bore, and
a first valve poppet movably disposed within the first valve bore; and
a second valve assembly, comprising:
a second valve housing connected to the first valve housing, the second valve housing defining a second valve bore, and
a second valve poppet extending from a plunger movably disposed within the second valve bore, the second valve poppet extending into the first valve bore and being arranged to selectively engage the first valve poppet.

2. The inflation valve assembly of claim 1, the first valve housing defining a first valve seat.

3. The inflation valve assembly of claim 2, engagement between the first valve poppet and the first valve seat inhibits a fluid flow between the first valve inlet and the first valve outlet.

4. The inflation valve assembly of claim 1, the first valve poppet defining a bleed port that extends from a first valve poppet first face towards a first valve poppet second face.

5. The inflation valve assembly of claim 4, a fluid cavity is defined by the first valve poppet second face, the first valve bore, and the second valve housing.

6. The inflation valve assembly of claim 5, the bleed port is arranged to fluidly connect the first valve inlet and the fluid cavity.

7. The inflation valve assembly of claim 5, the first valve poppet defining a valve port that is spaced apart from the bleed port, the valve port extending from the first valve poppet first face towards the first valve poppet second face.

8. The inflation valve assembly of claim 7, the first valve poppet defining a second valve seat.

9. The inflation valve assembly of claim 8, engagement between the second valve poppet and the second valve seat inhibits a fluid flow between the fluid cavity and the first valve outlet through the valve port.

10. An inflation valve assembly, comprising:
a first valve assembly, comprising:
a first valve housing defining a first valve inlet, a first valve outlet, a first valve seat, and a first valve bore, and
a first valve poppet movably disposed within the first valve bore and arranged to selectively engage the first valve seat to selectively inhibit fluid flow between the first valve inlet and the first valve outlet, the first valve poppet defining a bleed port that extends from a first valve poppet first face towards a first valve poppet second face and a second valve seat that extends from the first valve poppet second face; and
a second valve assembly, comprising:
a second valve housing connected to the first valve housing, the second valve housing defining a second valve bore,
an actuator assembly extending into the second valve bore, the actuator assembly having a plunger movably disposed within the second valve bore and
a second valve poppet extending from the plunger and into the first valve bore.

11. The inflation valve assembly of claim 10, the first valve poppet defining a valve port that is spaced apart from the bleed port, the valve port extending between the first valve poppet first face towards the first valve poppet second face.

12. The inflation valve assembly of claim 11, the bleed port having a first cross-sectional form and the valve port having a second cross-sectional form that is greater than the first cross-sectional form.

13. The inflation valve assembly of claim 11, a fluid cavity is defined by the first valve poppet second face, the first valve bore, and the second valve housing.

14. The inflation valve assembly of claim 13, a fluid flow received through the first valve inlet flows through the bleed port to pressurize the fluid cavity.

15. The inflation valve assembly of claim 14, wherein pressurizing the fluid cavity increases sealing forces of the first valve poppet and the second valve poppet.

16. The inflation valve assembly of claim 14, the second valve assembly further comprising: a solenoid assembly and a biasing member disposed between the solenoid assembly and the plunger.

17. The inflation valve assembly of claim 16, the biasing member arranged to bias the plunger towards the first valve poppet such that the second valve poppet engages the second valve seat to inhibit a fluid flow through the valve port.

18. The inflation valve assembly of claim 16, responsive to actuation of the solenoid assembly, the plunger spaces the second valve poppet apart from the second valve seat to evacuate the fluid cavity through the valve port and the first valve outlet.

19. The inflation valve assembly of claim 18, responsive to flow through the valve port, the fluid cavity is depressurized to decrease sealing forces of the first valve poppet and the second valve poppet.

20. The inflation valve assembly of claim 18, responsive to flow through the valve port, the first valve poppet moves towards the second valve housing such that the first valve poppet is spaced apart from the first valve seat.

21. The inflation valve assembly of claim 20, the first valve housing defining a stop that extends into the first valve bore, the stop being arranged to engage the first valve poppet second face to inhibit further movement of the first valve poppet towards the second valve housing.

22. The inflation valve assembly of claim 20, the spacing apart of the first valve poppet from the first valve seat fluidly connects the first valve inlet and the first valve outlet.
